(19) United States
(12) Patent Application Publication
(10) Pub. No.: US 2007/0154016 A1
(43) Pub. Date: Jul. 5, 2007

(54) Token-based distributed generation of security keying material

(76) Inventors: Madjid F. Nakhjiri, Palatine, IL (US); Mahsa Nakhjiri, Palatine, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/326,000

(22) Filed: Jan. 5, 2006

(51) Int. Cl. H04K 1/00

(52) U.S. Cl. 380/270

(57) ABSTRACT

A method and apparatus for delegating distribution of security keying material for the communication path between a mobile entity and a network service function, to the mobile entity. An authorization token is issued to the mobile entity which then supplies security keying material for the communication path. The keying material may be created by the Mobile entity itself. The mobile entity sends the security path material and the authorization token to a network service function. The network service function checks the authorization token to determine if the mobile entity is authorized to create the key material. If so, the received keying material is installed for use in securing the communication path with the mobile entity. The network service function may also be issued with a token to show that it is trusted by the issuer of the token.

### FIELD OF THE INVENTION

This invention relates generally to the field of computer networks. More particularly, this invention relates to the generation and passing of security keying material in a network.

### BACKGROUND

In a network with a security architecture, a mobile entity (ME) (also called a mobile node, a user or a client) gains access to computer resources on the network via an edge device (ED), such as a base station, network access server, network access point, access router, or base router. Access to the network is often controlled by an authentication, authorization, and accounting (AAA) framework that, in addition to controlling access to the network, controls policy enforcement, auditing usage, and provides the information necessary to bill for services.

Many new security architectures, such as those described in IEEE 802.1X standards (802.11i and the emerging 802.16, for example), combine the initial authentication and access control with key management. IEEE standard 802.1X is an example of a network access control standard. The control, which is used predominantly in Wi-Fi wireless networks, keeps a network port disconnected until authentication is completed. Depending on the results, the port is either made available to the user, or the user is denied access to the network.

The initial mutual authentication is a very lengthy process involving many round trips between the mobile entity and a central AAA server through the edge device. The edge device and the mobile entity do not trust each other initially. The initial authentication leads to a master key (often called AAA-key) between the mobile entity and the AAA server that is unknown by the edge device. The master key is then ported to the edge device and is later used by the mobile entity and edge device to perform a mutual authentication (during which the two prove the possession of the master key) and a new handshake to derive the traffic encryption keys (TEK's) used to protect link traffic.

In a network that supports mobility, the mobile entity may need to handover to a new edge device, such as a new base station, to receive better coverage. The new edge device is called the target edge device. The mobile entity must first perform mutual authentication and establish a TEK with the target edge device. In order to be able to expedite the handover procedure, it is desired to eliminate the full authentication process. If the mobile entity and the network prove that they still hold the master keys, the new traffic encryption keys can be generated very quickly without going through the full authentication process. However, the target edge device would still need access to the master key to start the TEK exchange with the mobile entity. Since many handovers are possible and hence many edge devices can be involved, it is not wise to send the initial master key (AAA-key) to the edge device as this would compromise the security of both the network and the user if one edge device is compromised (stolen or loaded with Trojan horses). Thus, instead of sending the AAA key to edge device, it has been suggested (for IEEE standard 802.16e, for example) that an edge device specific key (called a pair-wise master key, PMK or AAA-BS key) be created for the edge device. Although the PMK is a derivative of the AAA-key, the AAA key cannot be recovered from the PMK so security is not compromised. The mobile entity is familiar with the derivation process and can arrive at a PMK for the edge device it is moving to. Once the PMK is moved to the edge device, the mobile entity can start a new TEK handshake with the edge device. Since each edge device receives its own copy of the master keys, neighboring edge devices cannot derive the TEKs and thereby interpret user's traffic.

However the issue with this more secure approach is how to get the PMK to each target edge device in a timely manner either prior to or during handovers. This means, for example, that the AAA server must mediate every time the mobile entity needs to establish trust with a new edge device. This is time consuming since it involves round trips to the AAA server. It also consumes AAA CPU bandwidth, since the AAA server must be involved in every handover. Sending keys proactively to the edge device also has disadvantages, since it requires that the AAA server has a database of neighboring edge device and needs to push the keys to the target edge device proactively (which is a problem for the RADIUS protocol).

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagrammatic representation of a network consistent with certain aspects of the present invention.

FIG. 2 is a flow chart of a method for issuing authorization tokens consistent with certain embodiments of the present invention.

FIG. 3 is a flow chart of a method for distribution of keying material consistent with certain embodiments of the present invention.

FIG. 4 is a diagrammatic representation a method for distribution of keying material consistent with certain embodiments of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

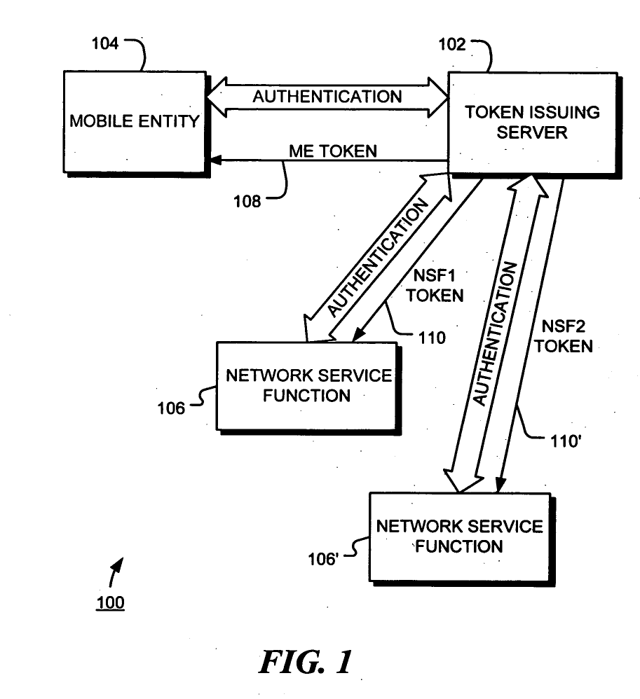

FIG. 1 is a diagrammatic representation of a network consistent with certain aspects of the present invention. Referring to FIG. 1, the network 100 includes a token issuing server 102, a mobile entity 104, and one or more network service functions 106, 106′.

The token issuing server 102 may be an Authentication, Authorization, and Accounting (AAA) Server, a Key Distribution Center (which can include an authenticator), a Network Access server, a Home Location Register, an Authentication Center, an Extensible Authentication Protocol (EAP) authenticator, a Home Subscriber Server, or similar device.

The mobile entity 104 is also called a mobile node, a user or a client. Examples of mobile entities include cellular telephones and mobile Internet devices.

A network service function 106 is an entity such as a base station, network access point, access router, mobile IP agent, base router, Virtual Private Network (VPN) gateway, key distribution center, Session Initiation Protocol (SIP) agent, authenticator, edge device or second mobile entity) with which the first mobile entity communicates.

In previous networks, the process of security key material generation is performed by a centralized resource such as an AAA server or a Key Distribution Center. This can result in slow response as a network increases in size.

In accordance with certain embodiments of the invention, the key material generation is delegated to a mobile entity 104 of the network. This reduces the processing burden on the centralized resource and speeds the response of the network.

The mobile entity 104 generates keying material for use by a network service function 106. In order to enable the mobile entity to prove that it is authenticated and authorized to generate this material, the mobile entity is issued with an authorization token. This token 108 is issued by the token issuing server 102.

In one embodiment, the one or more network service functions 106, 106′ may also be issued with authorization token 110, 110′ to enable the network service functions to prove that they are trusted by the token issuing server.

When the mobile entity 104 exchanges messages with the network service function, the mobile entity 104 also sends its authorization token 114 to the network service function 106. The network service function 106 checks the authorization token, and, if it is found that the token authorizes the mobile entity to generate the keying material, the keying material is accepted. Otherwise, the keying material is rejected. An error message may be sent if the keying material is rejected.

In this embodiment, the network service function and the mobile entity exchange tokens. The mobile entity 104 examines the authorization token of the network service function to determine if the network service function is to be trusted.

It will be apparent to those of ordinary skill in the art that the structure of the authorization token may take many forms and may include various information fields. Example information fields include:

Issuee Identifier (ME_ID or NSF_ID): An identification string of the entity to which the token is issued. This may be the mobile entity (ME) or network service function (NSF).

Issuer Identifier: An identification string of the token issuing server. This may be, for example, the identifier of the AAA server that issued the token. The issuer identifier allows for multi-operator authentication, by providing routing information for authentication and accounting data.

Policy Identifier: An identifier of what functions the mobile entity is authorized to perform and any associated rules. In one embodiment, the policy may define the type of the communication path and network service function that the authorization token can be applied to. For example, the link may be a cellular link, such as a 3G wireless link, an 802.11 link, or an 802.16 link. In a further embodiment the policy may define the type of network service function, such as a Mobile IP agent, a session initiation protocol (SIP) proxy or server, or an extensible authentication protocol (EAP) authenticator.

Token Validity Indicator: An indication of the conditions under which the mobile entity's authority to perform the delegated function will remain valid. This may be provided in the form of a time stamp and lifetime, for example.

Signature: A digital signature of the issuing entity. This may be, for example, an encrypted version of the other fields or an encryption of hash of other fields. The encryption may be performed using the private encryption key of the token issuing server or a key shared between the entity issuing the token and the entity verifying the token.

In one embodiment, in which the token issuing server is an AAA server, the authorization token for a mobile entity is described by the formula:
token=<ME_{—}ID, token_time_stamp, token_lifetime, Policy_{—}ID, E(AAA_private_key, ME_{—}ID|token_time_stamp|token_lifetime|Policy_{—}ID)>
where E(K, . . . ) denotes encryption using the key ‘K’, or the signature of the AAA server.

In another embodiment the token issuer could be a certificate Authority and the token can use the standard X.509 format.

In yet another embodiments the token may be signed using a group key where in the group key is known only to a set of NSFs and the AAA server. The group key can be located by using the AAA ID and the SPI that is known to the NSFs.
token=<AAA_{—}ID, SPI, nonce, Hash(Group Key, AAA ID|SPI|nonce)

In many embodiments the token may be signed using the private key of the token issuing server. The authorization token for a network service function may take a similar form, with the network service function's device identifier (NSF_ID) taking the place of the mobile entity identifier (ME_ID). More generally, the identifier will be the identifier of the token issuee, that it, the identifier of the entity to which the token is issued.

The policy identifier may indicate if the holder of the token is authorized to generate or to receive key material.

In the network shown in FIG. 1 the token issuing server issues the mobile entity 104 with an authorization token 108 following an initial authentication process. In an alternate embodiment the token may be pre-provisioned in the mobile entity. In any case the mobile will be issued with an authorization token 108.

A similar process may be followed for the issuance of authorization tokens (110 and 110′) to other network service functions (106 and 106′, respectively). The network service functions may receive the ME authorization token 108 as part of a message sent by the mobile entity or they may receive the token as part of a fetch procedure with a network server.

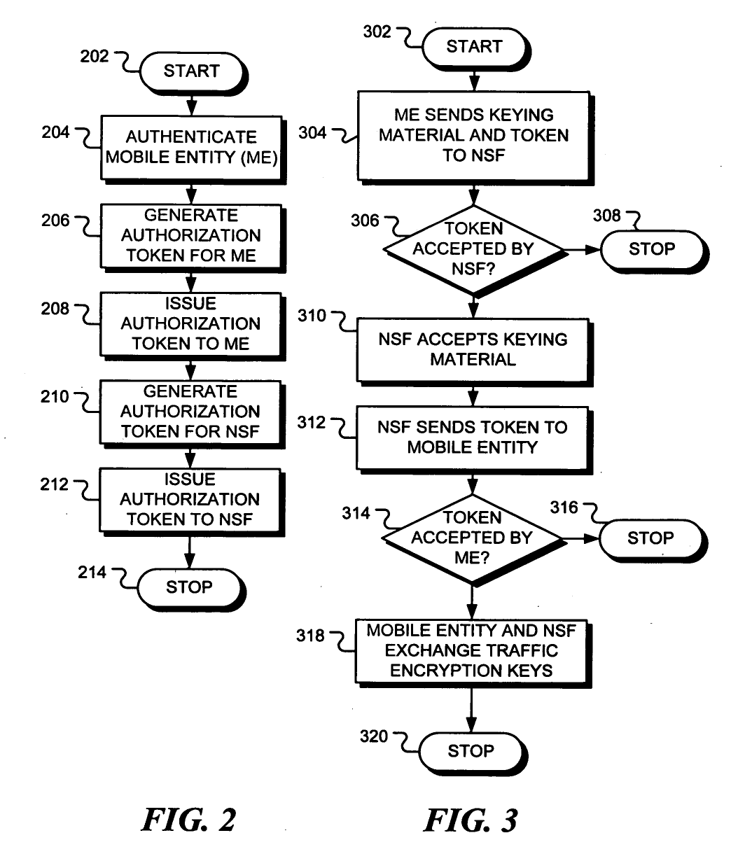

FIG. 2 is a flow chart of a method for authorization token issuance consistent with certain embodiments of the present invention. Following start block 202 in FIG. 2, a mobile entity is authenticated at block 204. At block 206, the token issuing server generates an authorization token for the mobile entity. The authorization token is used by the mobile entity to prove that is has the authority to generate keying material. The authorization token is issued to the mobile entity at block 208. At least some part of the token may be encrypted using the key issuing server's private encryption key. This enables the mobile entity to verify the source of the authorization token. The network service function (which is assumed to be part of the trusted network) may be, for example, a base station or a network access point in a wireless network. A token for the network service function is generated at block 210 and issued to the network service function at block 212. The authorization token allows the network service function to prove to other devices in the network that it is trusted. The process terminates at block 214 when all authorization tokens have been issued and delivered to their intended recipient.

FIG. 3 is a flow chart of a method for authorization token use consistent with certain embodiments of the preset invention. Following start block 302 in FIG. 3, at block 304 a mobile entity sends its authorization token to a target network service function. The target network service function processes the authorization token to determine if the mobile entity is authorized to provide keying material. The authorization may consist of the NSF verifying the signature in the token using the public key of token issuing server. In another embodiment this process may consist of the NSF determining the group key, using an AAA identifier and a connection identifier contained in the token, and verifying the signature using the embedded key. If the mobile entity is not authorized to provide keying material, as indicated by the negative branch from decision block 306, the process terminates at block 308 (an error message may be sent). If the mobile entity is authorized to provide keying material (that is, if the token is accepted), as indicated by the positive branch from decision block 306, the network service function accepts the keying material at block 310. The key provided by the ME may be fully or in part generated by the ME itself or obtained from a network server such as AAA server or pre-provisioned in the mobile. The keying material is used to secure the communication path from the network service function. At block 312, the network service function sends its authorization token to the mobile entity. At decision block 314, the mobile entity processes the token and determines if the network service function is to be trusted. If not, as indicated by the negative branch from decision block 314, the process terminates at block 316. If the network service function is to be trusted, as indicated by the positive branch from decision block 314, the mobile entity and the network service function exchange traffic encryption keys at block 318. Finally the process terminates at block 320.

One application of the present invention relates a method for decentralized and distributed generation of keying material for the handover between base stations (BS's) in a mobile network. However, keying material may be generated for other applications, such as for communication between a mobile entity and other network service functions (such as an access router, Mobile IP Agent, authenticator, key distribution center, SIP agent, VPN gateway or another mobile entity). Previously, the handover process required the new base station (the target base station) to obtain a master key from the AAA server or from a neighborhood key distributed center. However, the handover procedure is expedited if the mobile entity and the NSF can establish a secure communication path with each other without contacting the AAA server. This avoids having to perform the full authentication process with the AAA server at each handover. As part of the handover process, new traffic encryption keys (TEK's) are generated quickly.

As long as the AAA key that the mobile entity created during the initial full authentication with the AAA server is still valid, the mobile entity can create the AAA-BSt key before a handover to the target base station (BSt). Since no base station except the target base station should have access to the AAA-BSt key, the mobile entity encrypts this key with the public key of the target base station. The target base station decrypts the AAA-BSt key with its own private key. Now that both mobile entity and the target base station have the AAA-BSt key, they can start a TEK handshake to build the session keys.

However, it is important that the target base station be able to ensure that the mobile entity is a trusted mobile entity that has authenticated with the AAA server and is authorized to access the network. This problem is solved by the signed authorization token issued for the mobile entity by the AAA server. The authorization token shows that the owner that it is fully authenticated by the AAA server and is authorized by the AAA server to generate the AAA-BS key for any base station or other keys for other network authorities (specified by a policy). The key can be generated when needed by the mobile entity without the need for the AAA server to confirm the token. An example formulation of an authorization token is as follows:
token=<MSID, AAAID, token time stamp, token lifetime, Policy ID, E(AAA private key, MSID|AAAID|token time stamp|token lifetime|Policy ID)>,
where E(K, . . . ) denotes encryption using the key ‘K’ or a signature of the AAA server.

The encryption may be performed using an RSA algorithm, for example. The AAAID (an identifier of the AAA server) is included to allow the base station to determine whether it should trust the AAA server or the certificate authority (CA) that has generated the certificate for the AAA server. The AAAID is also useful for the base station to know where to send any accounting information relating the services the mobile has used.

In this embodiment, the token does not include the actual AAA key, since the AAA key should not be known to any entity other than mobile entity and AAA server. Instead, the AAA server may include hints such as AAA life time and time stamp (mentioned as token life time and time stamp) in the token. This timing information is also useful to avoid the security and network management issues related to token expiration. In an alternate embodiment, the AAA server can create a derived key from AAA key and include that in encryption. In that case the token would be:
token=<MSID, AAAID, token time stamp, token lifetime, Policy ID, Freshness value E(AAA private key, Hash(derived key, MSID|AAAID|token time stamp|token lifetime|Policy ID)>,

where
derived key=Hash(AAA key, MN_{—}ID|Freshness value|“Derived Key”).

The hash is a one way function such as SHA1. The freshness value is optional and may be a for instance a time stamp or a random number. If included the freshness value may already be known to the ME or provided to it by the AAA server. Note that in this embodiment, the AAA key is also part of process or deriving the token, but is not provided to the ME as part of the token itself. In one instance, the ME will need to provide the derived key also to the NSF thereby proving that it has the AAA key. In another instance the AAA server can encrypt the derived key using a key it shares with NSFs and include it in the token. When the mobile sends a message it must use the derived key to obtain a keyed hash of the message. The NSF will then verify the hash by first obtaining the derived key and then verifying the hash there by confirming that the mobile entity has the AAA key.

The policy ID is an optional field that allows the AAA server to enforce a policy (understandable by the base station or other receiving entity) that indicates what sort of keys the mobile entity is allowed to generate and the scheme used to generate the token. Examples are technology-specific key material (as described in IEEE standards 802.16 or 802.11, for example), and application specific key material (for Mobile Internet Protocol or Virtual Private Networks, for example). When sending the encrypted AAA-BS key to the target base station, the mobile entity includes its token, other information such as its identifier and timing information. If a derived key is needed then that is also sent to the target BS. It then signs this information (by encrypting it) with its private key or a key that can be generated from the AAA key (such as the AAA-BS key itself).

The keying material sent from the mobile entity to network service function, such as a base station, may be sent securely using the public key of the network service function or a shared key created through a Diffe-Hellman exchange with the network service function. The derived key may also be similarly protected. In some embodiments the key and the token are both sent encrypted.

Whenever an entity passes a token to another entity (mobile entity to NSF or vice versa), the sending entity needs to sign the message including the token to avoid other mobile entities or NSFs misuse the token. The mobile entity signature on its token can prevent other mobile entities from stealing the token related to a mobile entity. Note that if another node replays the message, it will not have access to the keying material. Furthermore, the mobile entity can include a freshness value such as a timestamp or ‘nonce’ (a randomly chosen value, different from previous choices), to protect against replays.

Alternatively, the mobile entity can send any randomly generated key instead of the AAA-BS key to the base station (since the token allows the mobile entity to generate any key).

It is desirable for the mobile entity to be able to determine if the base station is also an entity that is trusted by the AAA server. To facilitate this, in one embodiment the AAA server issues a token for each base station (at the time of base station initialization, for example) so that the base station can present the token to any mobile entity that arrives at the base station. In one embodiment, the base station token is calculated as:
TBS_token=BSID|AAAID|token time stamp|token lifetime|Policy ID|E(AAA private key, BSID|AAAID|token time stamp|token lifetime Policy ID).
In another embodiment, the BS may have a certificate issued by a trusted CA which is used to authenticate the BS to the ME.

The life time for the base station token can be different, typically much longer, than that for the mobile entity token. The base station may sign any sort of anti-replay data including the base station nonce that can be used for TEK generation later. The token time stamp and token lifetime indicate the period of validity of the token.

The keying material distribution process described above is a completely distributed and decentralized approach controlled by the mobile entity. As long as both the base station and the mobile entity trust the AAA server, the mobile entity can provide handover keying materials that are trusted by the base station without the need for any reference to the AAA server. In certain embodiments at least part of key may be provided by the AAA to the MSS. The process preserves the integrity of each base station, while it does not assume that base stations share any keying material related to the mobile entity. It does not assume any trust relationship between base stations.

Other benefits of the approach are that it aids with network administration, such as accounting and reduces load on the AAA server while, at the same time, allowing for roaming to foreign AAA domains as long as AAAF (the AAA foreign agent) and AAAH (the AAA home agent) have trust and business relationships.

Keying material for multiple access technologies can be generated by the mobile entity (rather than from the AAA server) as long as the operator trust agreements exist.

The keying material available at the mobile entity may be used to create further keying material. For the example, the mobile entity may create child keys that are derived from the initial key or create fresh keys when a previous key expires. If the network service function is itself a key distribution center, the keying material generated by the mobile entity may also be used as a master key.

The keying material generated by the mobile entity may be used in the initial authentication process that is required for key exchange mechanisms such as those used for establishing an Internet Protocol Security (IPSec) VPN connection.

It will be apparent to those of ordinary skill in the art that keying material for many network applications, such as Mobile IP, VPN gateways and SIP proxies, can be created this way.

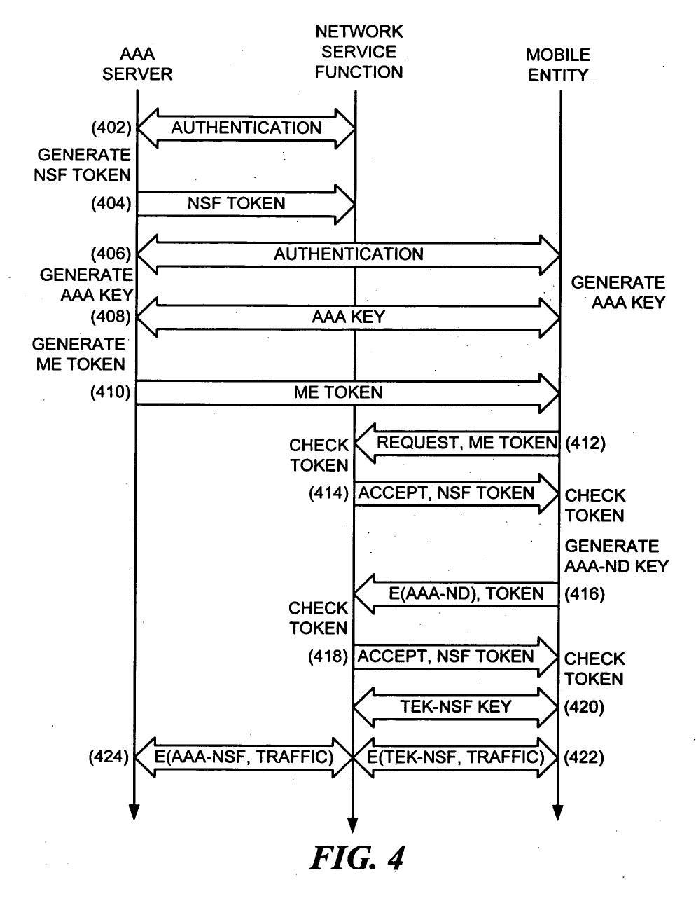

FIG. 4 is a diagrammatic representation a method for delegating the creation and distribution of keying material consistent with certain embodiments of the present invention. In this embodiment the token issuing server is an AAA server. Referring to FIG. 4, following authentication 402 of the network service function by the AAA server, the AAA server generates a token for the network service function and passes this token to the network service function at 404. Similarly, following authentication 406 of the mobile entity by the AAA server, the AAA server and the mobile entity both generate an AAA key at 408. The AAA server also generates an authorization token for the mobile entity and passes this token to the mobile entity at 410. The mobile entity is now authorized to create security keying material for the communication path between the mobile entity, a network service function and the network.

In one embodiment of the invention, the mobile entity and the network service function exchange tokens before security keying material is passed to the network service function. For example, the mobile entity may pass its authorization token to the network service function together with a request for the token of the network service function at 412. The network service function verifies the token and, if the token is accepted, responds with its own token 414. If the mobile entity accepts the token, the creation and distribution of security keying material continues. In a different embodiment, the NSF may authenticate itself to the ME before the ME sends the token and in yet another they may happen in parallel.

In a further embodiment of the invention, this exchange of token occurs with the passing of the keying material. The key and the mobile entity's token are sent to the network service function at 416. The mobile entity may use keys generated as part of authentication of the mobile entity to create the security keying material sent to the network service function.

The ME-NSF MK key may be sent from the mobile entity to the network service function securely, using public key of the network service function or a shared key created through a Diffe-Hellman exchange with the network service function. The network service function verifies the authorization token and installs the received keying material for use in securing the communication path. The network service function responds with it own token at 418, allowing the mobile to verify that the network service function is trusted by the AAA server (if this was not done during a previous token exchange). At 420 the mobile network and the network service function exchange traffic encryption keys. Finally, at 422 and 424, the mobile entity can communicate with the AAA-server along a secure communication path using the keying material generated and distributed by the mobile entity.

It will be apparent to those of ordinary skill in the art that the methods described above, or variants thereof, can be used in other applications. For example, they may be used to provide peer to peer security in ah-hoc networks.

The methods described in embodiments herein, may be implemented using programmed processors executing programming instructions that can be stored on any suitable electronic storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for delegating distribution of security keying material for the communication path between a mobile entity and a network service function, to the mobile entity, the method comprising:
issuing a first authorization token corresponding to the mobile entity;
the mobile entity obtaining security keying material;
the mobile entity sending the security keying material to a network service function; and
the network service function obtaining and verifying the authorization token and installing the received security keying material for use in securing the communication path with the mobile entity.

2. The method of claim 1, wherein the security keying material is obtained using a method selected from a group consisting of the mobile entity deriving it locally, a token issuing server supplying it, and the security keying material being pre-provisioned in the mobile entity.

3. The method of claim 1, wherein the authorization token corresponding to the mobile entity is issued by a token issuing server selected from a group consisting of an AAA server, a certificate authority and a Key Distribution Center.

4. The method of claim 1, wherein the security keying material is sent by the mobile entity to the network service function securely using at least one key selected from a group consisting of the public key of the network service function, a group key shared between the network service function and token issuing server and a shared key created through a Diffe-Hellman exchange with the network service function.

5. The method of claim 1, further comprising creating further keying material using the security keying material provided by the mobile entity.

6. The method of claim 1, wherein the mobile entity obtaining the security keying material comprises the mobile entity creating the security keying material using keys generated as part of the authentication of the mobile entity.

7. The method of claim 1, wherein the authorization token comprises at least one field selected from a group of fields consisting of a mobile entity identifier, a token issuing server identifier, a token validity indicator, a policy identifier, and a digital signature.

8. The method of claim 1, wherein a second authentication token is issued to the network service function by an authority that the mobile entity trusts and wherein the network service function presents the second authentication token to the mobile entity.

9. A method for a server to delegate distribution of security keying material to a mobile entity, the method comprising:
the server generating a first token for the mobile entity, the first token authorizing the mobile entity to distribute security keying material; and
issuing the token to the mobile entity;

10. The method of claim 9 wherein a signature in the token generated by the token issuing server includes a proof that the mobile entity possesses a key that is known only to the mobile entity and the token issuing server.

11. A method for generation of security keying material by a mobile entity of a network, the method comprising:
the mobile entity receiving a first authorization token from a token issuing server of the network;
the mobile entity obtaining security keying material corresponding to a network service function of the network;
the mobile entity passing the encrypted security keying material and the first authorization token to the network service function.

12. A method in accordance with claim 11, further comprising:
the mobile entity receiving an second authorization token from the network service function; and
the mobile entity processing the second authorization token to determine if the network service function is trusted by the token issuing server.

13. A method in accordance with claim 11, further comprising the mobile entity exchanging a traffic encryption key with the network service function.

14. A network service function operable to provide a secure communication path between a server and a mobile entity, the network service function comprising:
a first network port operable to receive a first authorization token issued by a trusted token issuing server;
a second network port operable to receive a first keying material from an mobile entity;
a processor operable to process the first authorization token to determine if the mobile entity is authorized to create security keying material for the communication path and to install the first keying material from an mobile entity.

15. A network service function in accordance with claim 14, wherein the processor is further operable to verify that the Mobile Entity has possession of an AAA key shared between the Mobile entity and an AAA server.

16. A network service function in accordance with claim 14, wherein the processor is further operable to derive additional key material from the first keying material

17. A network service function in accordance with claim 14, wherein the second network port is further operable to pass a second authorization token to the mobile entity of the network; and wherein the second authorization token comprises information indicating if the network service function is to be trusted by the server.

18. A mobile entity of a network, comprising
a memory containing an authorization token issued by a token issuing server of the network, the authorization token evidencing that the mobile entity is authorized to distribute security keying material;
a processor operable to obtain security keying material for a network service function of the network; and
a network port operable to pass security keying material and the authorization token to the network service function.

19. A mobile entity in accordance with claim 18, wherein the processor further operable to provide proof of the procession of an AAA key that is shared between the mobile entity and an AAA server.

20. A mobile entity in accordance with claim 19, wherein the processor is further operable to encrypt the security keying material using one of a public encryption key of the network service function, and a Diffe-Hellman key.

21. A network server comprising:
a processor operable to generate an authorization token corresponding to an authenticated mobile entity; and
wherein the authorization token authorizes the mobile entity to create security keying material for a network service function of the network for use in securing a communication path with the mobile entity.

22. A network server in accordance with claim 21, wherein the processor is further operable to generate an authorization token corresponding to the network service function.

23. An authorization token for issuance to a mobile entity of a network, the authorization token comprising:
an identifier of a token issuing server that issued the authorization token;
an identifier of the mobile entity;
a policy identifier; and
a digital signature of a token issuing server,
wherein the authorization token authorizes the mobile entity to distribute security keying material in accordance with a policy indicated by the policy identifier.

24. An authorization token in accordance with claim 23, further comprising a validity indicator.

25. An authorization token in accordance with claim 23, wherein the token is signed using a key that is known to the token issuing server but not known to the mobile entity.

26. An authorization token in accordance with claim 23, wherein the security keying material is used to secure a communicate path between the mobile entity and a network service function.
